(19) United States
(12) Patent Application Publication
(10) Pub. No.: US 2012/0226862 A1
(43) Pub. Date: Sep. 6, 2012

(54) EVENT TRANSPORT SYSTEM

(75) Inventors: James Grafton, Teddington (GB); Stephen Milne, London (GB)

(73) Assignee: INTERNATIONAL BUSINESS MACHINES CORPORATION, Armonk, NY (US)

(21) Appl. No.: 13/326,231

(22) Filed: Dec. 14, 2011

(30) Foreign Application Priority Data
Dec. 15, 2010 (EP) 10195210.9

(51) Int. Cl. G06F 9/46; G06F 12/08

(52) U.S. Cl. 711/118; 719/318; 711/E12.017

(57) ABSTRACT

A method for communicating events from an event source to an event consumer is disclosed herein. In one embodiment, such a method includes monitoring an event generation rate associated with an event source. The method further determines if the event generation rate exceeds a threshold rate. Upon receiving an event from the event source, the method generates a condensed version of the event if the event generation rate exceeds the threshold rate. The method then communicates the condensed version to an event consumer. A corresponding system and computer program product are also disclosed.

### RELATED APPLICATIONS

This application claims priority to European Patent Application No. 10195210.9 filed on Dec. 15, 2010 and entitled EVENT TRANSPORT SYSTEM.

### BACKGROUND OF THE INVENTION

Components and systems often interoperate using events such as messages, data items, database entries, or other suitable constructs for exchanging information. In general, an event is generated at an event source and is communicated to an event consumer. The communication takes place over an event transport. An event source and event consumer may be any component suitable as the origin and/or target of events such as computer systems, software applications executing on computer systems, operating systems, hardware devices, network components, mobile devices, components of computer systems, middleware, or the like.

An event transport is a mechanism for communicating an event from an event source to an event consumer. Between interconnected computer systems, an event transport may include a wired or wireless network or a combination of such networks. Between communicating applications, an event transport may include interfaces such as application programming interfaces, data interfaces, streams, storage, or databases. Such interfaces may involve the use of wired or wireless networks. Additional components may be included in the event transport such as buffers, queues, caches, or the like.

During use, the rate that events are generated and communicated over the event transport may vary. Events may be generated irregularly resulting in periods where rates are low and other periods where rates are high. High event generation rates may burden an event consumer receiving the events since the event consumer may need to store, process, respond to, or otherwise react to the events. As the event generation rate (and consequential rate of communication) increases, the event consumer may become so burdened that the consumption of events from the event transport undesirably effects the operation of the event consumer. For example, the consumption of events may undermine the ability of the event consumer to undertake other aspects of its processing.

Events flowing between an event source and an event consumer may be regulated using event transport components such as buffers, queues, caches, or the like. Such components may act as temporary stores for events transported between event sources and event consumers to regulate the rate the events are received. In this way, some of the burden caused by high event generation rates may be removed from an event consumer. However, such techniques have the disadvantage that they delay the reception of events by the event consumer.

In view of the foregoing, what are needed are mechanisms to allow events to be communicated from event sources to event consumers without negatively affecting the performance of the event consumers, even when event generation rates are high. Further needed are mechanisms to enable the events to be delivered to the event consumers with minimal delay.

### SUMMARY

Embodiments of the invention have been developed in response to the present state of the art and, in particular, in response to the problems and needs in the art that have not yet been fully solved by currently available systems and methods. Accordingly, embodiments of the invention have been developed to provide systems and methods to more effectively communicate events from event sources to event consumers. The features and advantages of the invention will become more fully apparent from the following description and appended claims, or may be learned by practice of the invention as set forth hereinafter.

Consistent with the foregoing, a method for communicating events from an event source to an event consumer is disclosed herein. In one embodiment, such a method includes monitoring an event generation rate associated with an event source. The method further determines if the event generation rate exceeds a threshold rate. Upon receiving an event from the event source, the method generates a condensed version of the event if the event generation rate exceeds the threshold rate. The method communicates the condensed version to an event consumer.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 is a block diagram showing one example of a computer system suitable for use with various embodiments of the invention;

FIG. 2 is a schematic block diagram showing one embodiment of an event transport system in accordance with the invention;

FIG. 3 is a flow diagram showing one embodiment of a method executed by an event transport system in accordance with the invention; and

FIG. 4 is a schematic block diagram showing an alternative embodiment of an event transport system in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for carrying out operations of the invention may also be written in a low-level programming language such as assembly language.

The present invention may be described below with reference to flowchart illustrations and/or block diagrams of methods, apparatus, systems, and computer program products according to various embodiments of the invention. It will be understood that each block of the flowchart illustrations and/or block diagrams, and combinations of blocks in the flowchart illustrations and/or block diagrams, may be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

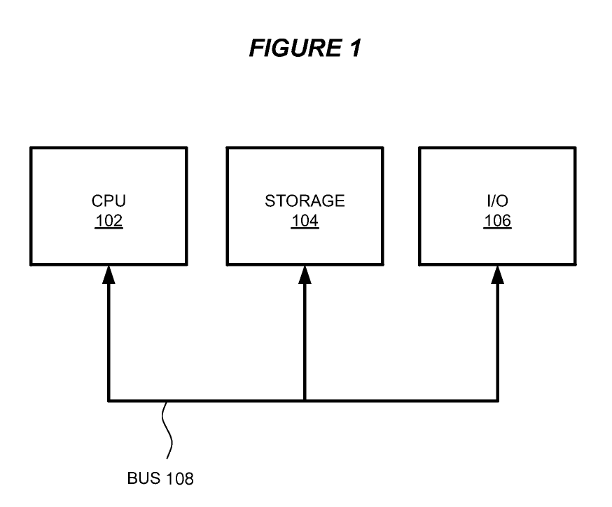

FIG. 1 is a block diagram showing one example of a computer system suitable for use with various embodiments of the invention. As shown, a central processing unit (CPU) 102 is communicatively coupled to one or more storage devices 104 and an input/output (I/O) interface 106 via a data bus 108. The storage devices 104 may include read/write storage devices such as random access memories (RAM) or non-volatile storage devices. An example of a non-volatile storage device includes a disk or tape storage device. The I/O interface 106 interfaces with systems or devices for the input or output of data, or for both input and output of data. Examples of I/O devices that may communicate through the I/O interface 106 include a keyboard, mouse, display (such as a monitor), and a network connection.

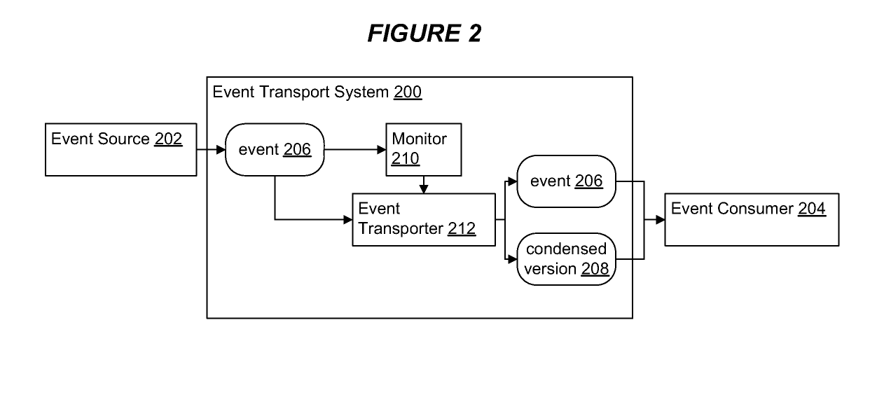

FIG. 2 is a schematic block diagram showing one embodiment of an event transport system 200 in accordance with the invention. The event transport system 200 is configured to communicate events from an event source 202 to an event consumer 204. The event source 202 is a generator of events for communication to the event consumer 204. In certain embodiments, the event source 202 is separated from the event transport system 200 by other components residing between the event source 202 and the event transport system 200. Similarly, certain components may separate the event transport system 200 from the event consumer 204.

The event transport system 200 is a mechanism for communicating an event 206 from the event source 202 to the event consumer 204. The event transport system 200 may be implemented entirely in hardware, entirely in software configured to operate hardware, or as a combination of both hardware and software. For example, the event transport system 200 may include a network, providing data communications, and software components to transport events over the network. Alternatively, the event transport system 200 may include software components that provide an interface between software applications.

As shown, the event transport system 200 includes a monitor 210 (implemented in either hardware and/or software) that monitors the rate that events are generated by the event source 202. The monitor 210 is further configured to determine if the rate that events are generated by the event source 202 exceeds a threshold rate. The threshold rate may be specified by an operator or user of the event transport system 200, or can be determined automatically based on data or other criteria. Furthermore, the threshold rate may be specified for the entire event transport system 200, for one or more event consumers 204, for one or more event sources 202, or the like. In certain embodiments, the threshold rate is changeable, such as dynamically changeable.

The event transport system 200 further includes an event transporter 212 for communicating events 206 to the event consumer 204. In certain embodiments, the event transporter 212 is configured to generate a condensed version 208 of an event 206 for communication to the event consumer 204. The condensed version 208 may be a reduced or compressed version of an event 206.

In one embodiment, the event transporter 212 uses condensing rules to determine how a condensed version 208 is generated for an event 206. Such condensing rules may specify parts, fields, data items, or elements of an event 206 that should be included in the condensed version 208. Other aspects of the event 206 may be omitted from the condensed version 208. Alternatively, the condensing rules may specify parts, fields, data items, or elements of an event 206 that may be omitted from the condensed version 208. The condensing rules may be included in or referenced by the event transporter 212. Alternatively, the condensing rules may be stored anywhere accessible to the event transporter 212. In certain embodiments, the condensing rules are global to the entire event transport system 200 and applicable to all events received by the event transport system 200. In alternative embodiments, the condensing rules are specific to one or more event consumers 204. In yet other embodiments, the condensing rules specify compression, archival, or reduction algorithms or techniques for use in reducing the size of an event 206 to generate a condensed version 208.

During operation, the event transport system 200 receives events 206 from the event source 202 and monitors, via monitor 210, the rate that events are generated by the event source 202. When the event generation rate does not exceed a threshold rate, the event transporter 212 communicates any event 206 it receives to the event consumer 204. When the event generation rate exceeds the threshold rate, the event transporter 212 does not immediately communicate the event 206 to the event consumer 204, but instead generates a condensed version 208 of the event 206. The condensed version 208 may be promptly communicated to the event consumer 204. Alternatively, the event 206 may be communicated to the event consumer 204 at a later time, such as when the event generation rate is relatively low, either in its entirety or in part to communicate parts of the event 206 not included in the condensed version 208.

Thus, as indicated above, the event transport system 200 may be configured to provide a condensed version 208 of an event 206 to an event consumer 204 so that the event consumer 204 has less information to process. This will ideally reduce the effect that received events will have on the operation of the event consumer 204. Furthermore, the condensed version 208 is promptly communicated to the event consumer 204 instead of caching, queuing, or buffering the event 206. This allows the event consumer 204 to promptly respond to the event 206.

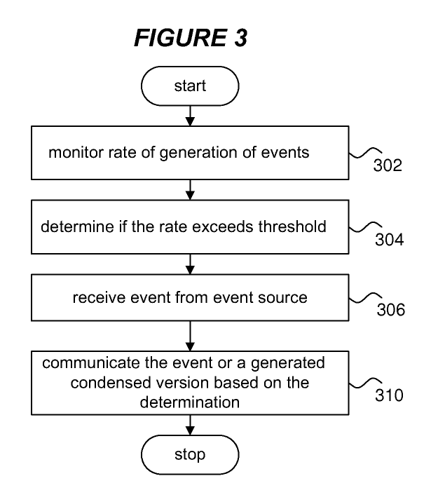

FIG. 3 is a flow diagram showing one embodiment of a method executed by an event transport system 200 in accordance with the invention. As shown, at step 302, the method monitors the rate that events are generated by the event source 202. At step 304, the method determines whether the rate exceeds a threshold rate. At step 306, an event 206 is received from the event source 202. At step 310, if the threshold rate is exceeded, the method communicates a condensed version 208 of the event 206 to the event consumer 204. On the other hand, if the threshold rate is not exceeded, the method communicates the event 206 to the event consumer 204.

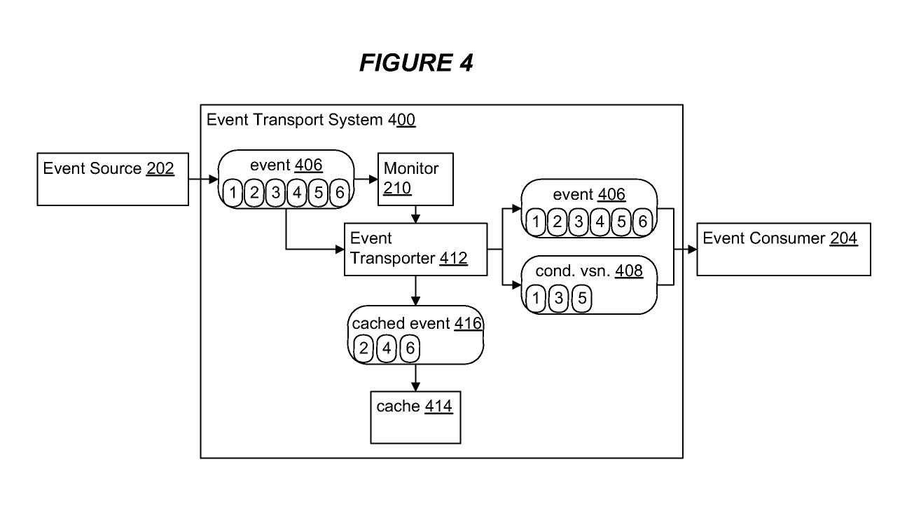

FIG. 4 is a schematic block diagram showing an alternative embodiment of an event transport system in accordance with the invention. Many of the features of FIG. 4 are identical to those described above with respect to FIG. 2 and thus will not be repeated. In the embodiment of FIG. 4, events generated by an event source 202 include a set of event parts, such as a set of fields, elements, data items, rows, attributes, or other constructs suitable for storing part of an event. For example, event 406 includes six parts numbered one through six. It will be appreciated by those in the art that events can include any number of suitably identifiable parts including headers, tails, footers, and other constructs of fixed or variable length.

The event transporter 412 of FIG. 4 is configured to generate a condensed version 408 of an event 406 having a subset of the parts of the event 406. The particular subset of parts may be defined in condensing rules associated with the event transport system 400 or the event consumer 204. For example, the subset of parts may be defined in the condensing rules as a subset of required parts or a subset of parts that are not required, thereby indirectly indicating a remaining subset of parts that are required. In certain embodiments, the condensing rules are dynamically adjusted based on the event generation rate determined by the monitor 210. For example, in the embodiment illustrated in FIG. 4, the condensed version 408 includes only parts one, three, and five of the event 406. Thus, a condensing rule may identify these parts as required or identify parts two, four, and six as inessential.

As shown, the event transport system 400 of FIG. 4 includes a cache 414 to store events 406. In the illustrated embodiment, the event transporter 412 is configured to store events 406 in the cache 414 when the monitor 210 determines that the event generation rate exceeds a threshold rate. At a later time, such as when the threshold rate is no longer exceeded, the event transporter 412 communicates the event 406 or events 406 stored in the cache 414 to the event consumer 204.

In one embodiment, the event transporter 412 stores only those parts of events 406 that are not stored in the condensed versions 408. In this way, the cache 414 only stores those parts of an event 206 that are not communicated to the event consumer 204 in the condensed version 408, thereby reducing the required storage in the cache 414. Thus, the event transporter 412 may be configured to generate a cached event 416 containing only those fields not included in the condensed version 408.

In certain embodiments, the cache 414 has a storage capacity that is dynamically resizable such that, if the cache is full, the storage capacity of the cache 414 can be increased. Furthermore, in certain embodiments, events stored in the cache 414 may be discarded based on caching rules. Such caching rules may be specific to individual event consumers 204 or may be applicable to the entire event transport system 200. Such caching rules may also be associated with the condensing rules used to create the condensed versions 408. In certain embodiments, the dynamically resizable cache 414 allows the storage capacity of the cache 414 to be reduced when events are discarded therefrom.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. An event transport system for communicating events from an event source to an event consumer, the event transport system comprising:
a monitor to monitor an event generation rate associated with an event source and determine if the event generation rate exceeds a threshold rate; and
an event transporter to communicate an event generated by the event source to a event consumer, the event transporter configured to generate a condensed version of the event for communication to the event consumer if the event generation rate exceeds the threshold rate.

2. The event transport system of claim 1, wherein the event includes a set of event parts and the condensed version includes a subset of the event parts.

3. The event transport system of claim 2, wherein the event transport system comprises a cache for storing at least a portion of the event.

4. The event transport system of claim 3, wherein the cache stores event parts that are excluded from the subset of event parts in the condensed version.

5. The event transport system of claim 2, wherein the subset of event parts is based on a rule defined for the event consumer, the rule being variable based on the event generation rate.

6. The event transport system of claim 3, wherein the cache has a storage capacity that is dynamically resizable such that, if the cache is full, the storage capacity of the cache can increase.

7. The event transport system of claim 6, wherein the cache is configured to discard cached events based on a cache rule.

8. The event transport system of claim 7, wherein the storage capacity of the cache is reduced when cached events are discarded from the cache.

9. A method for communicating events from an event source to an event consumer, the method comprising:
monitoring an event generation rate associated with an event source;
determining if the event generation rate exceeds a threshold rate;
receiving an event from the event source;
generating a condensed version of the event if the event generation rate exceeds the threshold rate; and
communicating the condensed version to an event consumer.

10. The method of claim 9, wherein the event includes a set of event parts and the condensed version includes a subset of the event parts.

11. The method of claim 10, further comprising storing at least a portion of the event in a cache.

12. The method of claim 11, wherein storing at least a portion of the event in a cache comprises storing, in the cache, event parts that are excluded from the subset of event parts in the condensed version.

13. The method of claim 10, further comprising determining the subset of event parts based on a rule defined for the event consumer, the rule being variable based on the event generation rate.

14. The method of claim 11, further comprising dynamically resizing a storage capacity of the cache such that, if the cache is full, the storage capacity of the cache can increase.

15. The method of claim 14, further comprising discarding cached events from the cache based on a cache rule.

16. The method of claim 15, further comprising reducing the storage capacity of the cache when cached events are discarded from the cache.

17. A computer program product for communicating events from an event source to an event consumer, the computer program product comprising a non-transitory computer-readable storage medium having computer-usable program code embodied therein, the computer-usable program code comprising:
computer-usable program code to monitor an event generation rate associated with an event source;
computer-usable program code to determine if the event generation rate exceeds a threshold rate;
computer-usable program code to receive an event from the event source;
computer-usable program code to generate a condensed version of the event if the event generation rate exceeds the threshold rate; and
computer-usable program code to communicate the condensed version to an event consumer.

18. The computer program product of claim 17, wherein the event includes a set of event parts and the condensed version includes a subset of the event parts.

19. The computer program product of claim 18, further comprising computer-usable program code to store at least a portion of the event in a cache.

20. The computer program product of claim 19, wherein storing at least a portion of the event in a cache comprises storing, in the cache, event parts that are excluded from the subset of event parts in the condensed version.
